(19) United States
(12) Patent Application Publication
(10) Pub. No.: US 2013/0248125 A1
(43) Pub. Date: Sep. 26, 2013

(54) Window Covering Having a Lift System Utilizing Conical Spools

(71) Applicant: Tzong-Fu Lin, Taipei (TW)

(72) Inventor: Tzong-Fu Lin, Taipei (TW)

(73) Assignee: WHOLE SPACE INDUSTRIES LTD, Taipei (TW)

(21) Appl. No.: 13/424,511

(22) Filed: Mar. 20, 2012

(51) Int. Cl. E06B 9/303; E06B 9/32; A47H 23/04; A47H 5/03

(52) U.S. Cl. 160/84.05; 160/331; 160/170; 160/84.04

(57) ABSTRACT

A window covering has an upper rail and lift cords that extend from the upper rail to window covering material. The lift cords are wound onto respective conical spools when the window covering material is retracted and is unwound from the spools when the window covering material is extended. The conical spools move along a portion of the length of a shaft that couples the conical spools to a spring motor when the window covering material is moved from a retracted position to an extended position. The lift cords are unwound from the spools so that a segment of the lift cord that extends from the spool through a hole in the headrail is positioned adjacent a portion of the spool that has a smaller diameter when the window covering material is in the extended position as compared to when the window covering material is in the retracted position.

### FIELD OF INVENTION

The present invention relates to window coverings.

### BACKGROUND OF THE INVENTION

Window coverings utilize a lift system that may be actuated to lift or lower a window covering material. Examples of window coverings include, for example, Venetian blinds, pleated shades, cellular shades, Roman shades, roll-up shades or other types of shades or blinds. Such window coverings often utilize a lift system for controlling the raising and lowering of the window covering and also maintaining a selected position of the window covering. U.S. Pat. Nos. 6,964,291, 6,325,131, 5,482,100, 5,328,113 and 13,251 and U.S. Published Patent Application Publication No. 2001/0035269 disclose examples of window covering lift systems.

Some lift systems utilize a cord operated lift system. Usually such window coverings have at least one operator cord. An operator cord may be a cord that extends from a cord lock or portions of lift cords that extend through a cord lock. A user may grasp those one or more operator cords to move the cords out of the cord lock to raise a position of the window covering or release the cord lock to permit the cords to pass through the cord lock for purposes of lowering the position of the window covering.

Such operator cord lift systems can pose problems to a user of the window covering. For instance, the exposed operator cords can pose a strangulation danger to small children. As another example, a user can have difficulty operating such cords to raise or lower a window covering. A user may have difficulty moving a cord so that the cord lock releases the cord. The user may also have difficult pulling multiple cords out of a cord lock to raise the shade so that the shade is even when raised to a new position.

Lift systems of window coverings may alternatively use a spring motor. Such lift systems, however, often require use of other elements in addition to a spring to account for the strength of a spring and the changing amount of weight of the window covering material that is supported by the spring of the spring motor when the window covering material is raised or lowered at different positions. For example, button actuated brakes are often used in addition to the spring motor to maintain a desired position of a blind. Such additional features are often needed to help maintain a position of a window covering.

For instance, without the use of a brake, the spring of the spring motor may be unable to reliably hold a position of the window covering material. Instead, the spring may weaken over time and a position of the window covering may lower or may apply too much force and slowly raise window covering material from a selected position. The use of a brake or other element for engaging or otherwise stopping lift cords to account for such problems adds cost to the design of a window covering. Additionally, it can require a user to press an actuator such as a button, which may be undesirable to a customer.

A new window covering design is needed that permits a spring motor to operate without the need of any brake or other element to help supplement the operation of the spring motor. Such a window covering is preferably configured as a cordless window covering so that use of an operator cord extending from a cord lock is not needed for purposes of raising or lowering the shade.

### SUMMARY OF THE INVENTION

A window covering includes a first rail, window covering material and a lift system. The window covering material is positioned adjacent to the first rail and is moveable from a retracted position to an extended position. The lift system is positioned adjacent to the first rail. The lift system includes a spring motor unit, a shaft coupled to the spring motor unit, a plurality of conical spools attached to the shaft such that rotation of the shaft also causes rotation of the conical spools and a plurality of lift cords. The shaft is coupled to the spring motor unit so that the shaft is rotatable in a first direction to retract the window covering material and is also rotatable in a second direction opposite the first direction to extend the window covering material. Each of the conical spools has a channel through which a portion of the shaft passes. Each of the conical spools is attached to the shaft such that rotation of the shaft in the first direction also causes rotation of the conical spool in the first direction and rotation of the shaft in the second direction also causes rotation of the conical spool in the second direction. Each of the conical spools has a first end portion that has a smaller diameter than a second end portion of that spool. Each of the conical spools is also moveable along the shaft so that the conical spool moves along a length of the shaft during rotation of the shaft. Each of the conical spools is moveable from a first position along the length of the shaft when the window covering material is in the retracted position to a second position along the length of the shaft when the window covering material is in the extended position. Each of the lift cords extends from a respective one of the conical spools. Each of the lift cords has a first segment that extends from the conical spool to which it extends through the first rail that is positioned adjacent to the first end portion of that conical spool when the window covering material is in the retracted position. Each of the lift cords has a second segment that extends from the conical spool from which that lift cord extends through the first rail that is positioned adjacent to the second end portion when the window covering material is in the extended position.

In some embodiments, each of the lift cords pass through the first rail by passing through a respective aperture formed in the first rail. Alternatively, the lift cords may all pass through the first rail by passing through a slot or hole formed in the first rail. Each of the lift cords may be comprised of cord material, polymeric material, be a strip of material having a width of between one and seven centimeters, or be a flexible elongated member.

The window covering material may be any of a number of possible materials. For instance, the window covering material may be woven fabric, interconnected fabric segments, non-woven fabric, cellular material, slats on ladders, pleated material, faux wood, woven wood, bamboo, a film, or woven grass.

Some embodiments of the window covering may also include a second rail. The second rail may be a bottom rail. The first rail may be a headrail in some embodiments of the window covering. In other embodiments of the window covering that are configured as a top down bottom up shade, the first rail may be either a headrail of the shade or a middle rail of the shade that is moveable relative to a headrail and the bottom rail.

Some embodiments of the window covering may utilize a lift system that also includes tubular members. Each of the tubular members may be attached to a respective one of the conical spools. Each of the tubular members may have a channel through which a portion of the shaft passes. Each of the tubular members may be attached to the shaft such that the tubular members rotate when the shaft rotates. The lift system could also include seating elements attached to the first rail. Each of the seating elements may have a hole through which a portion of the shaft passes. For each seating element, a respective one of the tubular members may pass through the hole in the seating element when the seating element when the window covering material is moved from the retracted position to the extended position.

The shaft of the lift system may be composed of wood, a composite material, metal or a polymeric material. The shaft may be a circular cross section or be polygonal in cross section. For instance, the shaft may be a rod or an elongated member having a rectangular, hexagonal, or octagonal cross section.

In some embodiments of the window covering the lift cords include a first and second lift cords and the conical spools include first and second conical spools. The spring motor unit may include a first spring that extends from a first roller to a second roller. The lift system may also include a first tubular member attached to the first conical spool and a second tubular member attached to the second conical spool. First and second seating elements may be attached to the first rail as well. The first seating element may have a first hole through which a portion of the shaft passes and through which a portion of the first tubular member move when the window covering material moves from the extended position to a retracted position. The second seating element has a second hole through which a portion of the shaft passes and through which a portion of the second tubular member moves when the window covering material moves from the extended position to the retracted position. The first end of the first tubular member may be attached to the first conical spool and the second end of the first tubular member may move from the first side of the first seating element to the second side of the first seating element when the window covering material is moved from the retracted position to the extended position. A first end of the second tubular member may be attached to the second conical spool and the second end of the second tubular member may move from adjacent a first side of the first seating element to a position adjacent a second side of the second seating element when the window covering material is moved from the retracted position to the extended position.

Other details, objects, and advantages of the invention will become apparent as the following description of certain present preferred embodiments thereof and certain present preferred methods of practicing the same proceeds.

### BRIEF DESCRIPTION OF THE FIGURES

FIG. 1 is an exploded view of a first present preferred embodiment of my window covering.

FIG. 2 is a front view of the first present preferred embodiment of my window covering in a raised, or retracted, position. A portion of the headrail is cut away to illustrate the lift system positioned therein

FIG. 3 is a front view of the first present preferred embodiment of my window covering in a lowered, or extended, position. A portion of the headrail is cut away to illustrate the lift system positioned therein.

### DESCRIPTION OF PRESENT PREFERRED EMBODIMENTS

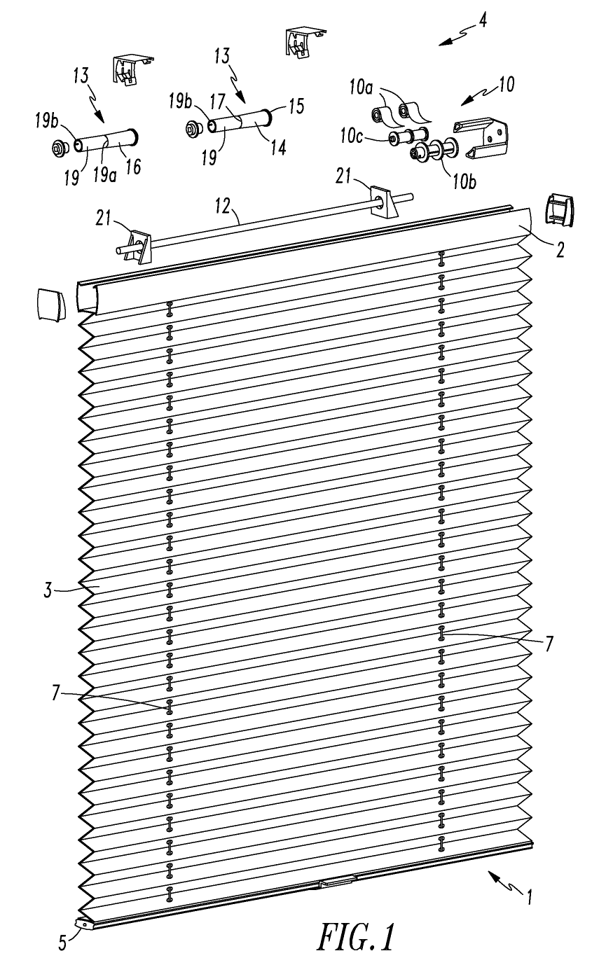

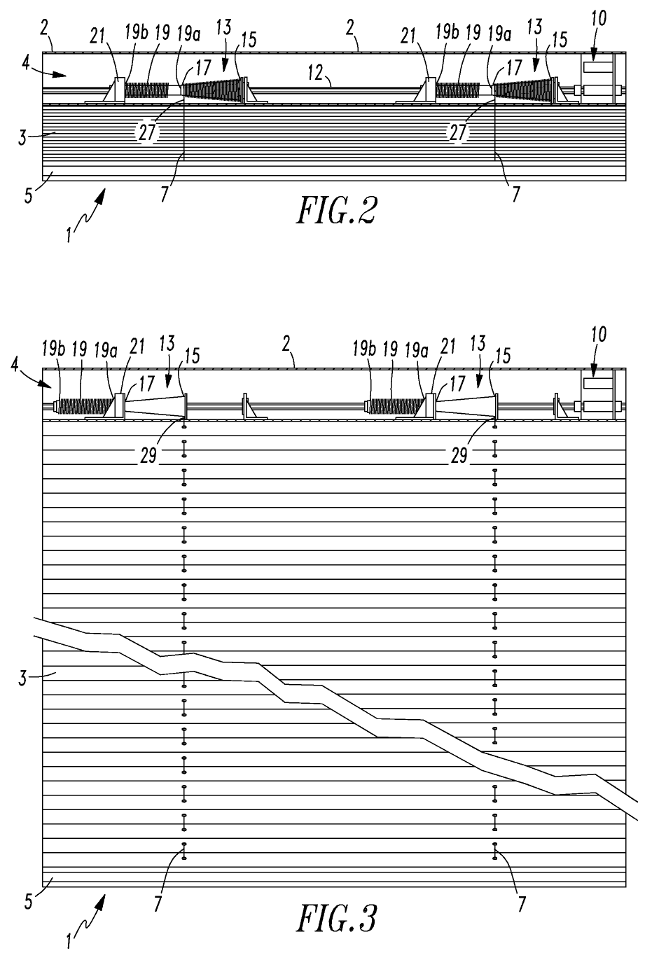

Referring to FIGS. 1-3, a window covering 1 may have a headrail 2, window covering material 3 positioned adjacent the headrail 2, a bottom rail 5 and a lift system 4. The lift system may be attached to the headrail or may be positioned within the headrail. The bottom rail 5 may be attached to the bottom of the window covering material 3 or may be attached to a terminal end of each lift cord 7 that may pass through the window covering material 3. The window covering material 3 is moveable from a retracted position as shown in FIG. 2 to an extended position as shown in FIG. 3. In some embodiments of the window covering 1, the retracted position of the window covering material 3 may be considered as corresponding to a raised position of the window covering 1 and the extended position of the window covering material 3 may correspond to a fully lowered position of the window covering 1.

The lift cords 7 may be composed of cords, narrow strips of material that are one to seven centimeters in width, elongated polymeric members, or other types of flexible elongated members that may be wound and unwound from a spool and pass through window covering material. The lift cords may extend from conical spools 13. Each of the lift cords 7 may be wound onto and unwound from a respective one of the conical spools 13. The lift cords 7 may be unwound from the conical spools 13 when the window covering material 3 is moved to the extended position and may be wound about the conical spools 13 when the window covering is moved from the extended position to the retracted position.

The conical spools 13 may include a first conical spool 14 and a second conical spool 16. The conical spools may be shaped like a cone or generally shaped like a cone. For instance, the conical spools 13 may be shaped like a cone, shaped like a truncated cone or shaped like a frustum. Each conical spool 13 may have a first end 15 and a second end opposite the first end 17. The first end 15 may have a larger diameter than the second end 17. Each of the conical spools may also have a channel defined throughout the length of the spool.

Each of the conical spools may be attached to a tubular member 19. Each tubular member 19 may have a first end 19a attached to an end of the conical spool and a second end 19b opposite that first end. Each tubular member 19 may be a tubular body that is cylindrical, rod-like, or shaft-like in shape and has a channel defined through the length of the body.

A shaft 12 may pass through the channels formed in the tubular members 19 and conical spools 13. An end of the shaft 12 may be coupled to a spring motor unit 10. The spring motor unit 10 may contain one or more than one springs or spring motors. In some embodiments, the other end of the shaft 12 could be coupled to another spring motor unit (not shown). The shaft 12 may be coupled to the spring motor unit 10 so that the shaft rotates in a first direction when the window covering material is retracted and rotates in a second direction that is opposite the first direction when the window covering material is extended. The tubular members 19 and conical spools 13 may be attached to the shaft such that the conical spools 13 and tubular members 19 rotate in the same direction in which the shaft 12 rotates. The shaft may have a polygonal cross section or a rounded cross section and may be composed of a metal such as aluminum or steel, a plastic, a composite material, or wood.

The spring motor unit 10 may include one or more first rollers 10a and one or more second rollers 10b. Springs 10c may extend from a respective one of the first rollers 10a to a respective one of the second rollers 10b. The rollers 10a and 10b and springs 10c may be at least partially enclosed by a housing such as a spring box or carriage. The size and shape of the spring box, carriage or other housing may be any of a number of sized and shapes configured to help position the spring motor unit 10 within the headrail 2 or help attach the spring motor unit 10 to the headrail 2.

The springs 10c are preferably configured to provide a changing amount of force along the length of the spring. Such a changing amount of force may be due to a change in width or thickness of the spring or due to a heat treatment process that changes the strength of the spring without having to require a change in width or thickness.

Each spring 10c may be configured to be substantially wrapped around a first roller 10a when the window covering material 3 is in the retracted position and may travel to the second roller 10b while the window covering material is moved from the retracted position so that when the window covering material is in the extended position a substantial portion of the spring 10c is wrapped about the second roller 10b. Of course, the springs 10c may also move back around the first rollers 10a when the window covering material is moved back to the extended position.

The shaft 12 could be coupled to the spring motor unit 10 in a number of different ways. For instance, the end of the shaft coupled to the spring motor unit 10 could be attached within a hole of a post or shaft along which second rollers 10b of the spring motor unit 10 are positioned. As an alternative example, the end of the shaft coupled to the spring motor unit 10 could be attached to the first rollers 10a of the spring motor unit 10. As yet another example, a clutch or gear train could also be used to couple the shaft to the spring motor unit.

Seating elements 21 are attached within the first rail 2. The seating elements may have body that has any of a number of different sizes and shapes for being positioned and attached within or to a headrail. For example, the size and shape of the seating element may be selected based upon the size and shape of a headrail or size and shape of a desired window covering configuration.

The seating elements 21 are sized and configured for connecting a conical spool, a tubular member, or both a conical spool and a tubular member to the headrail. Each of the seating elements 21 may have a hole through which a portion of the shaft 12 passes. A portion of each tubular member 19 may also pass through the hole in a respective one of the seating elements 21. For instance, as may be appreciated from FIGS. 2 and 3, the second end 19b of each tubular member may pass through a hole in a respective one of the seating elements 21 so that the first end 19b moves from being adjacent to a first side of the seating element to be positioned on an opposite second side of the seating element 21 when the window covering material 3 is moved from the retracted position to the extended position. The portion of the tubular member 19 may be an entire portion of the tubular member or may be a substantial portion that extends from the second end 19b to a position adjacent the first end 19a of that tubular member 19a. Of course, when the window covering material is moved from the extended position to the retracted position, the tubular members 19 may move back through the holes in the seating elements 21 to positions adjacent the first sides of the seating elements 21.

The tubular members 19 may be threaded so that the threads of the tubular members mate with threads formed around the hole of the seating element so that rotation of the tubular members that occurs when the shaft 12 rotates causes the tubular members 19 to move along a portion of the length of the shaft and through the holes in the seating elements 21. The first end 19a of each tubular member 19 may be attached to a respective one of the conical spools so that the movement of that tubular member also drives movement of the conical spool along a portion of the length of the shaft 12 when the window covering material is moved from a retracted position to an extended position. The tubular members 19 and conical spools 13 may move from a first position to a second position along the length of the shaft 12 when the window covering material is moved from the retracted position shown in FIG. 2 to the extended position shown in FIG. 3. The tubular members and conical spools may then move back from the second position along the length of the shaft 12 to the first position along the length of the shaft when the window covering material is moved from the extended position to the retracted position.

While the spools 13 and tubular members 19 move along the length of the shaft 12 as the window covering material is moved, the lift cords 7 may travel through holes in the headrail 2. The lift cords may extend from the conical spools and through the headrail 2 when the window covering material is extended and may travel through the holes and into the headrail for wrapping about the conical spools when the window covering material 3 is retracted. Each lift cord may pass through a respective hole formed in the headrail 2. Alternatively, the headrail 2 may have an elongated slot or large aperture sized to permit multiple lift cords to pass through the headrail 2.

The lift cords 7 are wound and unwound from the conical spools such that first cord segments 27 of the lift cords 7 extend from the conical spools 13 through the holes in the headrail 2 from a position adjacent the second ends 17 of the conical spools 13 when the window covering material is in the retracted position. As mentioned above, the first ends 15 have a larger diameter than the second ends 17. The lift cords 7 are unwound from the conical spools 13 when the window covering material 3 is moved to the extended position such that second cord segments 29 of the lift cords 7 extend from adjacent the first ends 15 of the conical spools through the holes in the headrail 2 when the window covering is in the extended position. The changing diameter of the conical spools permits a decrease in torque to be applied by the rotation of the shaft that occurs when the window covering material is lowered. Of course, when the window covering material is raised from the extended position to the retracted position, the lift cords 7 are wound about the conical spools 13 so that the second cord segments 29 are wound about the conical spools 13 and the first cord segments 27 again extend from adjacent the smaller diameter ends 17 of the conical spools through the holes in the headrail 2.

It should be appreciated that the use of a fixed hole in the headrail 2 for each lift cord helps locate the point in the headrail through which that lift cord passes into the window covering material when the window covering material 3 is raised and lowered. This fixed location within the headrail 3 functions in combination with the movement of the spools along the length of the shaft when the window covering is raised or retracted and the changing diameters of the spools to permit the lift system of the window covering to provide the strongest torque when the window covering material is in the retracted position and a the weakest torque when the window covering material is in the extended position. The amount of torque applied by the lift system changes from a weakest value to a strongest value as the position of the window covering material moves from the extended position to the retracted position. The changing of the torque applied by the lift system is affected by the strength of the springs of the spring motor unit, movement of the spools along the length of the shaft and the changing diameter of the conical spools that the lift cords are wound upon or unwound from.

Movement of the spools along the length of the shaft 12 along with the changing size of the diameter of the conical spools helps permit the spring motor unit to maintain a selected position of the window covering without the need of a friction brake or other brake mechanism. While a brake is not needed, it is contemplated that some embodiments of the window covering may still utilize a brake mechanism.

It should be understood that the operation of the lift system of the window covering may function as a cordless window covering. For instance, the raising and lowering of the window covering may be actuated without the use of an operator cord. A user may directly touch or move the window covering material 3 or bottom rail 5. For example, a user may pull the window covering material 3 down to overcome the force applied by the spring motor unit to maintain the position of the window covering material 3 until the window covering material is at a desired location. The user may then let go of the window covering material 3 or bottom rail and the spring motor unit 10 will continue to provide a force on the shaft to prevent further rotation of the shaft 12 to maintain the position of the window covering material 3. If a user wishes to raise the window covering, the user may simply apply a slight upward force to the bottom rail or bottom portion of the window covering material. The upward force provided by the user will result in the spring motor unit providing too much force and the springs 10c of the spring motor unit 10 will travel from one roller to another roller of the spring motor unit, which will cause the rollers to rotate and drive rotation of the shaft 12. The driven rotation of the shaft will cause the conical spools to rotate and move to wind the lift cords about the conical spools to retract the window covering material. When the window covering material 3 is at a desired raised location, the user may simply stop applying the upward force and the spring motor unit 10 will stop causing rotation of the shaft and will then maintain the position of the window covering material at its selected position until a user acts on the window covering 1 to change the position of the window covering material.

It should be appreciated that other variations of the present preferred embodiments discussed above may be made. For example, it is contemplated that various spring motor arrangements may be utilized for actuation of the lifting and lowering of the window covering material. As another example, the material choices for the window covering material may be any suitable material desired by a consumer, retailer or designer. For instance, the window covering material may be woven fabric, interconnected fabric segments, non-woven fabric, cellular material, pleated material, faux wood, woven wood, woven grass, bamboo, a film, slats on ladders, or other type of window covering material. As yet another example, embodiments of the window covering may be configured as a top down bottom up shade.

While certain present preferred embodiments of my window covering and certain embodiments of methods of practicing the same have been shown and described, it is to be distinctly understood that the invention is not limited thereto but may be otherwise variously embodied and practiced within the scope of the following claims.

What is claimed is:

1. A window covering comprising:
a first rail;
window covering material positioned adjacent to the first rail, the window covering material moveable from a retracted position to an extended position; and
a lift system positioned adjacent to the first rail, the lift system comprising:
a spring motor unit,
a shaft coupled to the spring motor unit, the shaft rotatable in a first direction to retract the window covering material and rotatable in a second direction opposite the first direction to extend the window covering material,
a plurality of conical spools, each of the conical spools having a channel through which a portion of the shaft passes, each of the conical spools attached to the shaft such that rotation of the shaft in the first direction also causes rotation of the conical spool in the first direction and rotation of the shaft in the second direction also causes rotation of the conical spool in the second direction, each of the conical spools having a first end portion and a second end portion, the first end portion having a smaller diameter than the second end portion, each of the conical spools also moveable along the shaft such that the conical spool moves along a length of the shaft during rotation of the shaft, each of the conical spools moveable from a first position along the length of the shaft when the window covering material is in the retracted position to a second position along the length of the shaft when the window covering material is in the extended position, and
a plurality of lift cords, each of the lift cords extending from a respective one of the conical spools, each of the lift cords having a first segment that extends from the conical spool from which that lift cord extends through the first rail positioned adjacent the first end portion of that conical spool when the window covering material is in the retracted position, each of the lift cords having a second segment that extends from the conical spool from which that lift cord extends through the first rail positioned adjacent to the second end portion of that conical spool when the window covering material is in the extended position.

2. The window covering of claim 1 wherein each of the lift cords pass through the first rail by passing through a respective aperture formed in the first rail.

3. The window covering of claim 1 wherein the lift cords all pass through the first rail by passing through a slot or hole formed in the first rail.

4. The window covering of claim 1 wherein each of the lift cords is comprised of cord material.

5. The window covering of claim 1 wherein the window covering material is woven fabric, interconnected fabric segments, non-woven fabric, cellular material, slats on ladders, pleated material, faux wood, woven wood, bamboo, woven grass or a film.

6. The window covering of claim 1 further comprising a second rail attached to at least one of the window covering material and the lift cords.

7. The window covering of claim 6 wherein the first rail is a headrail and the second rail is a bottom rail.

8. The window covering of claim 1 wherein the lift system is further comprised of tubular members, each of the tubular members attached to a respective one of the conical spools, each of the tubular members having a channel through which a portion of the shaft passes, each of the tubular members attached to the shaft such that the tubular members rotate when the shaft rotates.

9. The window covering of claim 8 wherein the lift system is further comprised of seating elements, the seating elements attached to the first rail, each of the seating elements having a hole through which the shaft passes, for each seating element, a respective one of the tubular members passing through the hole in the seating element when the window covering material is moved from the retracted position to the extended position.

10. The window covering of claim 9, wherein each of the tubular members passes through the hole in the respective one of the seating elements such that a first end of the tubular member is positioned on a first side of the seating element when the window covering material is in the extended position and the first end of the tubular member is positioned on a second side of the seating element when the window covering material is in the retracted position, the first side of the seating element being opposite the second side of the seating element.

11. The window covering of claim 1 wherein the shaft has a polygonal cross section.

12. The window covering of claim 11 wherein the shaft is a metal shaft.

13. The window covering of claim 1 wherein the lift cords are comprised of a first lift cord and a second lift cord and the conical spools are comprised of a first conical spool and a second conical spool.

14. The window covering of claim 13 wherein the spring motor unit is comprised of a first spring that extends from a first roller to a second roller.

15. The window covering of claim 14 wherein the lift system further comprises a first tubular member attached to the first conical spool and a second tubular member attached to the second conical spool, each of the first and second tubular members having a channel through which a portion of the shaft passes.

16. The window covering of 15 further comprising a first seating element attached to the first rail and a second seating element attached to the first rail, the first seating element having a first hole through which a portion of the shaft passes and through which a portion of the first tubular member moves through when the window covering material moves from the extended position to the retracted position, the second seating element having a second hole through which a portion of the shaft passes and through which a portion of the second tubular member moves through when the window covering material moves from the extended position to the retracted position.

17. The window covering of claim 16 wherein a first end of the first tubular member is attached to the first conical spool and the second end of the first tubular member moves from adjacent a first side of the first seating element to a position adjacent a second side of the first seating element when the window covering material moves from the retracted position to the extended position, the second side of the first seating element being opposite the first side of the first seating element and
a first end of the second tubular member being attached to the second conical spool and the second end of the second tubular member moving from adjacent a first side of the first seating element to a position adjacent a second side of the second seating element when the window covering material moves from the retracted position to the extended position, the second side of the second seating element being opposite the first side of the second seating element.

18. The window covering of claim 17 further comprising a second rail attached to at least one of the lift cords and the window covering material.

19. The window covering of claim 18 wherein the second rail is a bottom rail and the first rail is a headrail and wherein the spring motor unit, the conical spools, and the shaft are positioned within the first rail.

20. The window covering of claim 19 wherein the window covering material is woven fabric, interconnected fabric segments, non-woven fabric, cellular material, slats on ladders, pleated material, faux wood, woven wood, woven grass, or bamboo.
